(19) United States
(12) Patent Application Publication
(10) Pub. No.: US 2020/0408519 A1
(43) Pub. Date: Dec. 31, 2020

(54) 3D SCENE MODELLING SYSTEM BY MULTI-VIEW PHOTOGRAMMETRY

(71) Applicant: 4D VIEW SOLUTIONS, Grenoble (FR)

(72) Inventors: Clément MENIER, Grenoble (FR); Ronan BILLON, Grenoble (FR); Quentin PELORSON, Grenoble (FR)

(21) Appl. No.: 16/976,245

(22) PCT Filed: Feb. 28, 2019
(86) PCT No.: PCT/FR2019/050465

§ 371 Date: Aug. 27, 2020

(30) Foreign Application Priority Data
Mar. 1, 2018 (FR) 1851812

(51) Int. Cl. G01C 11/06; H04N 13/243; G06T 17/00

(52) U.S. Cl. CPC G01C 11/06; H04N 2013/0074; G06T 17/00; H04N 13/243

(57) ABSTRACT

A 3D modelling system for three-dimensionally modelling a scene by multi-view photogrammetry has cameras placed around the scene and grouped together in pairs that are spaced further apart from one another than the two cameras in each pair are spaced apart from each other, and a digital processing device that is configured to produce modelling data by applying stereoscopy processing by comparison firstly between the images of the scene that are produced by respective ones of the two cameras of a first and a second pair of cameras and secondly between the images produced by two cameras belonging to respective ones of the first and second pairs of cameras, the first and the second pairs of cameras being arranged respectively in a horizontal plane and in a vertical plane.

### TECHNICAL FIELD

The invention relates to a three-dimensional (3D) modelling system for modelling a scene three-dimensionally by multi-view photogrammetry.

### PRIOR ART

Multi-view photogrammetry comprises recording a set of pairs of plane views of a scene that make it possible to establish depth maps of the scene by stereoscopy, and then using the depth maps to obtain a 3D model of the scene by digitally implementing modelling algorithms.

An important, but not the only, application of the resulting 3D model is to generating virtual images of the scene as observed from arbitrary viewpoints.

Acquiring sequences of sets of simultaneous camera shots of the scene makes it possible generate videos of said scene from arbitrary observation angles.

Implementing multi-view photogrammetry of a scene in a studio requires monoscopic image-taking instruments such as cameras for taking stills or cameras for taking moving images, which instruments surround the scene to be modelled in such a manner as to observe it from a plurality of viewpoints.

In order to be optimal, 3D modelling is considered to require pairs of cameras that are aligned vertically or horizontally, and an angular distance between the cameras of each pair that lies in the range 5° to 15°.

For cost reasons, in practice, the arrangement mesh spaces at which the cameras are spaced apart are larger, mutually identical, and substantially square or rectangular, such as those in Patent Application FR 14 63073.

Conventionally, with cameras having set performance, increasing the quality of 3D modelling is understood by the specialists in this technical sector as requiring an increase in the number of cameras used, with immediate repercussions in terms of overall volume and cost of the equipment in the studio, in particular when video cameras are used.

Patent Application US 2006/0029256 discloses an imaging device comprising imaging units made up, in particular, of pairs of cameras, and reconstructing viewpoints that are different from the viewpoints of the cameras.

Publication Kanade T. et al.: “Virtualized Reality Constructing Virtual Worlds from Real Scenes”, IEEE Multimedia, IEEE Service Center, New York, US, Vol. 4, No. 1, 1997.01.01, pages 34-47, describes techniques for obtaining virtual 3D reconstructions from real images captured in a studio.

### SUMMARY OF THE INVENTION

The inventors of the present invention have determined that associations of cameras arranged in optimized manner around a scene to be modelled and having varied spacings between them for stereoscopic survey of the scene provide the modelling algorithms with a richness of information that is more substantial than if the associated cameras were arranged uniformly and with single, uniform spacing between them, and lead to qualitatively improving the modelling and make it possible to compensate for a small number of cameras.

An object of the invention is to improve the quality of the 3D modelling and/or to increase the modelling volume when modelling a scene by multi-view photogrammetry having a set number and a set type of cameras, compared with conventional approaches.

An alternative object of the invention is to maintain or to improve the quality of 3D modelling of a scene by multi-view photogrammetry while also increasing the modelling volume of the modelling of the scene and while reducing the number of cameras, compared with conventional approaches.

To this end, the invention provides a 3D modelling system for three-dimensionally modelling a scene by multi-view photogrammetry, which system comprises cameras that are designed to be grouped together in pairs of cameras that are placed around the scene to produce images of said scene with different viewpoints, the cameras in each pair of cameras having a certain intra-pair spacing between them, and a digital processing device that, from the images produced by the cameras, is configured to produce modelling data by applying stereoscopy processing by comparison between the images produced by respective ones of the two cameras of each pair of cameras, in which system said pairs of cameras are distributed around the scene in such a manner as to have inter-pair spacings between two adjacent pairs of cameras that are larger than said certain intra-pair spacing, in which system said digital processing device is further configured in such a manner as to apply stereoscopy processing by comparison between the images produced by a camera of a first pair of said cameras and the images produced by a camera of a second pair of said pairs of cameras, the second pair of cameras being adjacent to the first pair of cameras and spaced apart from said first pair of cameras by an inter-pair spacing that is greater than the intra-pair spacing, in order to produce additional modelling data, and in which system the cameras of said first pair of cameras are arranged side-by-side substantially in the same horizontal plane, and the cameras of said second pair of cameras are arranged one above the other substantially in the same vertical plane.

In particular, the modelling data obtained by stereoscopic processing comprise depth information deduced from a comparison between the viewpoints of two cameras, on the basis of which information it is possible to compute three-dimensional modelling of the scene.

The use of pairs of cameras that are spaced apart by relatively small amounts and that are in the same horizontal or vertical plane makes it possible to work with conventional binocular stereoscopy merger algorithms, without having to use “multi-baseline stereo” or “MBS” algorithms, which are more complex in terms of computation and are less effective.

In this system, the computation device models the scene on the basis of images in the form of camera shots taken by cameras spaced apart at a variety of spacings by adding to comparisons of data coming from pairs of cameras that are spaced apart by small amounts by adding to them comparisons of data obtained from cameras spaced further apart, thereby bringing a richness of information that is inaccessible when comparisons are made of data only coming from pairs of cameras with a single and small spacing between the cameras, and thereby making the modelling of better quality and more robust.

In addition, since the range of depths that can actually be surveyed by two cameras depends on the spacing between them, when advantage is taken of different spacings between cameras during processing by stereoscopy, the volume actually surveyed by all of the cameras is greater than if a single spacing were used.

Finally, spacings that are relatively wide between cameras make it possible to reduce their number while also covering the entire scene.

In particular, since the same camera is also used not only within the pair of which it is part but also in tandem with a camera of another pair, this increases the number of possible comparisons of data and thus the richness of information usable without increasing the number of cameras used.

The invention may advantageously also have the following features:
said camera of the second pair of cameras may be situated above the other camera of the second pair of cameras;
the cameras of the second pair of cameras may be situated lower than the cameras of the first pair of cameras; and
said camera of the first pair of cameras and said camera of the second pair of cameras may be aligned in a direction forming an angle lying in the range 5° to 20° with a horizontal plane or with a vertical axis;
said cameras may be distributed around the scene over a virtual surface in the shape of a sphere having a certain radius, it being possible for said certain intra-pair spacing to be such that an algebraic ratio of said certain spacing to said certain radius is less than 0.35;
said inter-pair spacings between two adjacent pairs of cameras may be larger than said certain intra-pair spacing by a factor at least equal to 1.4;
said cameras may be distributed around the scene in such a manner as to form a third pair of cameras having an inter-pair spacing with the second pair of cameras that is greater than or equal to the inter-pair spacing between the second pair of cameras and the first pair of cameras, and the computation device may be configured in such a manner as to apply said stereoscopy digital processing by comparison between the images produced by a camera of the third pair of cameras and the images produced by one of the cameras of the second pair of cameras, in order to produce additional modelling data;
the cameras of said third pair of cameras may be arranged side-by-side in the same horizontal plane; the third pair of cameras may be offset vertically relative to the first pair of cameras; said first and third pairs of cameras may be offset horizontally relative to each other and a camera of the third pair of cameras may be aligned vertically with a camera of the first pair of cameras; the second pair of cameras may be offset horizontally relative to the first and third pairs of cameras; and the computation device may be configured in such a manner as to apply stereoscopy digital processing by comparison between the images produced by the cameras of said first and third pairs of cameras that are in vertical alignment and/or between the images produced by the cameras of said second and third pairs of cameras, in particular the images produced by the other camera of the second pair of cameras and said camera of the third pair of cameras;
the inter-pair spacing between said first and third pairs of cameras may be greater than said certain intra-pair spacing and may be less than or equal to the inter-pair spacing between said second and third pairs of cameras; and
said first, second, and third pairs of cameras may define a pattern that is repeated around the scene.

### BRIEF DESCRIPTION OF THE DRAWINGS

The present invention can be better understood and other advantages appear on reading the following detailed description of an embodiment given by way of non-limiting example and with reference to the accompanying drawings, in which:

FIG. 1A is a perspective view of an arrangement of cameras around a scene in a first example;

FIG. 1B shows a portion of an arrangement of cameras in a second example, derived from the first example;

FIG. 2 shows cross-sections of the arrangement of FIG. 1A;

FIG. 3A shows an unrolled cylindrical projection of the arrangement of cameras of FIG. 1B;

FIG. 3B shows a portion of an unrolled cylindrical projection of the arrangement of cameras of FIGS. 1A and 2;

FIG. 3C shows a portion of FIG. 3A;

FIGS. 4A-1 to 4A-3 show variant arrangements of cameras around a scene;

FIG. 4B diagrammatically shows ranges of depths surveyed by pairs of cameras according to their spacings;

FIG. 5A shows the equipment of a photogrammetry studio;

FIG. 5B shows a table of associations between cameras; and

FIG. 5C is a diagram that diagrammatically shows the process for processing image data in a modelling system of the invention for modelling by photogrammetry.

### DESCRIPTION OF AN EMBODIMENT

In this example, a 3D modelling system for three-dimensionally modelling a scene by multi-view photogrammetry is constituted by a studio including a plurality of cameras surrounding a scene to be modelled, and a digital processing device connected to the cameras and equipped with at least one piece of software for processing image data.

The cameras may be distributed over a fictitious surface corresponding to a sphere such as the one in Patent Application FR 14 63073, or any other surface enabling the cameras to be distributed appropriately for observing the scene from multiple viewpoints.

In the context of photogrammetry, the cameras are monoscopic cameras, i.e. cameras each equipped with a single lens centered on a photosensitive sensor, such as cameras for taking still images or video cameras.

In the present document, the term camera generically covers monoscopic image-taking instruments such as cameras for taking stills, video cameras, or any other image-taking instrument that is capable of a generating a plane digital image from a given viewpoint.

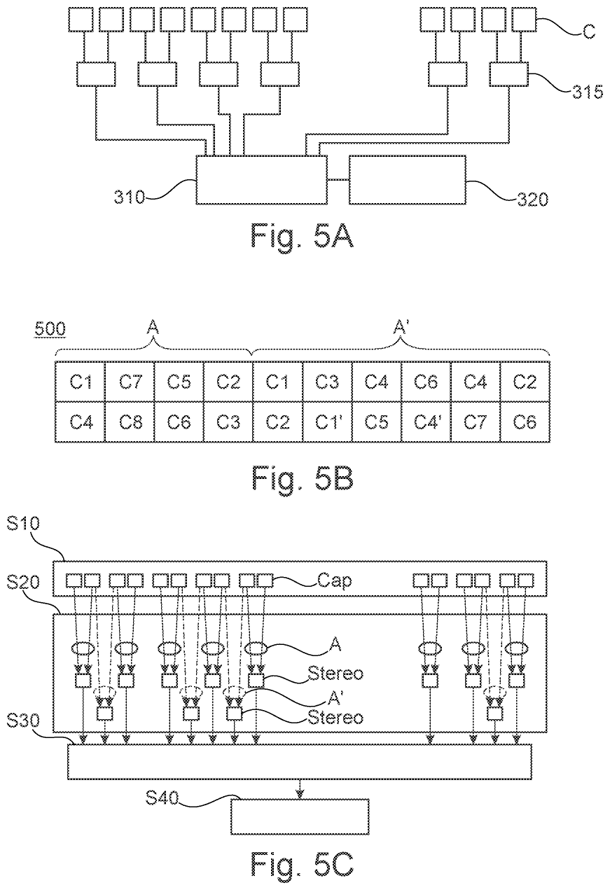

FIG. 5A shows the digital processing device 310, connected to the cameras C via intermediate computers 315 that may be provided with intermediate storage means for storing the image data coming from the cameras C, the number of cameras C connected to an intermediate computer 315 is arbitrarily set at two in this figure.

The digital processing device may consist of a network of computers that comprises at least one processor that is connected to data storage means 320, and that is equipped with an operating system, with an interface with a user, and with a plurality of pieces of image-processing software, e.g. for performing stereoscopy, 3D modelling, and/or four-dimensional (4D) modelling incorporating the three spatial dimensions and time for generating videos. Using the photogrammetry system of the invention does not require any particular computer processing or algorithm processing compared with conventional photogrammetry systems, so that a conventional photogrammetry computation system is quite capable of processing the data coming from the cameras of a photogrammetry system of the invention.

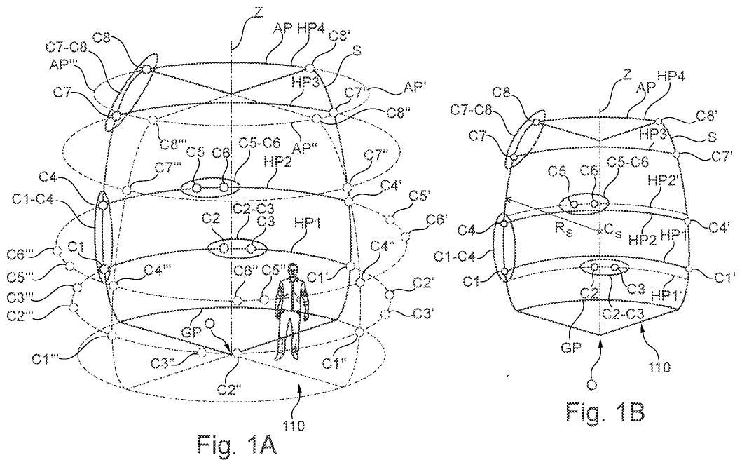

A first embodiment of the invention is shown by FIGS. 1A, 2, and 3B that show the arrangement of a set of 32 cameras over a fictitious surface S around a scene 110 to be modelled, which surface is centered on a vertical axis Z passing through a point O of the ground or floor of the studio.

In this first example, eight cameras C1 to C8, shown in solid (uninterrupted) lines, define an elementary pattern occupying an angular portion AP of 90° of the scene, and are distributed over four horizontal planes HP1 to HP4 that are offset vertically in that order relative to each other going upwards from bottom to top, above the plane GP representing the ground or floor of the studio.

The eight cameras are grouped together into four pairs of cameras that, in this example, have substantially the same intra-pair spacing e: two pairs C2-C3 and C5-C6, each of which is formed by two cameras substantially horizontally aligned relative to each other, and which pairs belong to respective ones of the horizontal planes HP1 and HP2; and two pairs C1-C4 and C7-C8 that are formed of four cameras C1, C4, C7 and C8 that are substantially vertically aligned relative to one another, at least when seen from a point situated on the axis Z, i.e. that are situated at the intersection of the surface S with a vertical plane containing the axis Z, and that are situated in respective ones of the horizontal planes HP1, HP2, HP3, and HP4.

The arrangement of the other 24 cameras, shown in dashed lines, defines an overall pattern that can be deduced by repeating the elementary pattern three times by rotations through a quarter turn, a half turn, and a three-quarter turn about the vertical axis Z, which rotations makes it possible to deduce the locations of the 24 cameras C1′ to C8′, C1″ to C8″ and C1“′ to C8”′, in respective ones of the three angular portions AP′, AP″ and AP′″.

In this example, the two pairs C2-C3 and C5-C6 are offset horizontally relative to each other by an amplitude corresponding to one intra-pair spacing e, in such a manner that camera C2 is, at least when seen from a point situated on the axis Z, substantially vertically aligned with camera C6, these two cameras, C2 and C6, being equidistant firstly from cameras C1 and C′1, and secondly from cameras C4 and C4′.

In this document, the expression “pair of cameras” designates two cameras spaced apart by a distance less than the distances between either one of the two cameras and any other camera of the system, so that each camera of the system has only one closest neighbor, unlike in conventional studios that have cameras distributed substantially uniformly around a scene to be modelled, so that each of those cameras has more than one closest neighbor.

In particular, in this configuration, and as described in detail below, the mesh coverage by cameras of a sphere for observing a scene exhibits a camera density that is non-uniform over the surface actually covered by said cameras, which may be characterized in that the cameras are arranged in an elementary pattern, each camera arranged at a given location in the elementary pattern having an own local environment that is substantially different from the local environments of the cameras arranged at the other locations in said elementary pattern.

An advantage of such a configuration lies in not being constrained by having to seek uniform distribution of the cameras, or a local environment that is similar for each camera, thereby making it possible to optimize to an advanced extent the placement of the cameras around the scene and to reduce their number, without that being to the detriment of the quality of the modelling of the observed scene.

In particular, in this document, the local environment of any given camera is defined by the positions, characterized by the directions and the distances of the other cameras in the system relative to said given camera, by considering at least the two cameras closest to said given camera, such as, for example, two cameras, three cameras, four cameras, or up to the number of cameras of the elementary pattern minus one.

For example, the cameras C1, C1′, C1″ and C1′″ all correspond to the same location of the elementary pattern that is defined by C1, and each of these cameras has an own local environment that is substantially different from those of the cameras C2 to C2′″, C3 to C3′″, C4 to C4′″, C5 to C5′″, C6 to C6′″, C7 to C7″′ and C8 to C8′″ corresponding to respective ones of the other locations of this elementary pattern that are defined by cameras C2 to C8.

In this example, the local environment of camera C1 may be characterized by the directions and distances of the four cameras C4, C5, C7 and C3′ relative to C1.

The mesh of cameras according to the repetition of the elementary pattern of this embodiment of the invention thus differs from a mesh of cameras that is constituted by regular patterns such as rectangles or triangles that are repeated in such a manner as to pave an observation surface such as a sphere surrounding the scene, and in which the cameras typically have own local environments that are substantially similar, the cameras at the edges of the mesh naturally having specific local environments.

The cameras of the pairs of cameras are preferably mutually aligned horizontally or vertically in order to maximize the quality of the information that can be obtained, this being due to the horizontal alignment of the sensors of these cameras because of the alignment of the “photosites”, i.e. of the light collecting areas or pixels, inside the sensors.

In particular, the camera sensors are conventionally constituted by photosensitive pixels distributed in rows and in columns that are perpendicular to the rows; thus, saying that two cameras are aligned horizontally means that said two cameras are arranged in the same horizontal plane, the rows of pixels of the sensors of said cameras being situated in said same horizontal plane; similarly, saying that two cameras are aligned vertically means that the cameras are arranged in the same vertical plane, the columns of pixels of the sensors of said cameras being situated in said same vertical plane; aligning the cameras of the pairs in this way enables the modelling algorithms to operate optimally within each pair of cameras.

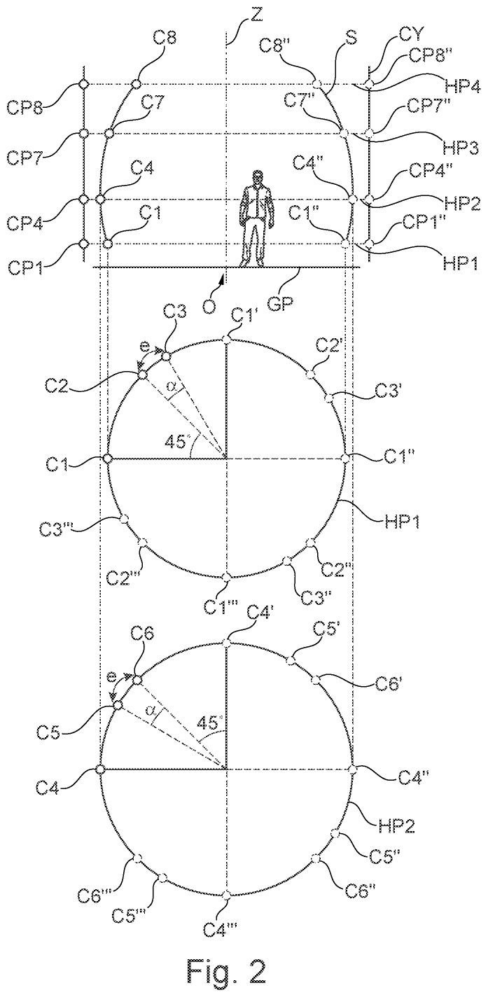

It may be advantageous for the cameras of the pairs to have an angular spacing a between them at a center of the scene that lies in the range 5° to 15°, as shown in FIG. 2 for the pairs C2-C3 and C5-C6, such a spacing conventionally being considered as making it possible to obtain stereoscopic information of good quality with respect to the computation algorithms.

Bringing the angle α closer to the upper limit of 15° contributes to minimizing the number of cameras necessary for good coverage of the scene while also maintaining the quality of the information obtained by the pairs of cameras.

In the particular situation in which triplets of cameras are used, namely a central camera flanked by two peripheral cameras surrounding the central camera and used in a trinocular vision unit, the pairs of cameras correspond to two of the cameras of a triplet, either the two peripheral cameras or the central camera and one of the peripheral cameras.

In the same way, in the particular situation in which quadruplets of cameras are used, namely four cameras used in a quadrinocular vision unit, the pairs of cameras correspond to two of the cameras of a quadruplet, this reasoning applying to any group of cameras operating as a vision unit.

FIG. 2 shows three sections through the arrangement of the cameras of FIG. 1A: a vertical section on axis C1-C1″ and two horizontal sections on planes HP1 and HP2.

FIG. 2 further shows a cylindrical projection of the locations of the cameras belonging to the vertical section along the axis C1-C1″ on a cylinder Cy of axis Z: cameras C1, C4, C7, C8, C1″, C4″ C7″ and C8″ are projected onto CP1, CP4, CP7, CP8, CP1″, CP4″, CP7″ and CP8″ respectively.

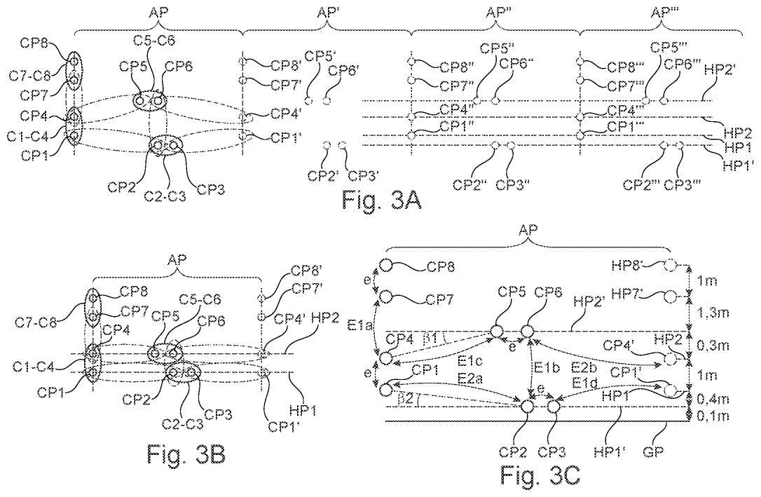

A second example, shown in FIGS. 1B, 3A, and 3C, differs from the first example shown in FIGS. 1A, 2, and 3B in that the pairs of cameras C2-C3 and C5-C6 are positioned respectively in a plane HP1′ that is lower than plane HP1, and in a plane HP2′ that is higher than plane HP2.

Apart from that aspect, the description of each of these two examples applies to the other and vice versa.

The general principles guiding the distribution of the cameras around the scene are as follows.

The density of the cameras is higher in a vertical range that is considered as more important for a future visualization of the scene and/or more sensitive because it faces portions of the scene that can be easily masked.

Thus, it may be advantageous to concentrate the cameras over a vertical range corresponding to a face height of a fictitious person contemplating the scene, either sitting down or standing up.

In addition, in the situation in which a scene having as its subject a person or a character, an arm of the character may mask the character's face at a given camera situated substantially at eye level, thereby requiring multiple images to be taken at nearby heights, and thus requiring multiple cameras, in order to guarantee that the subject is covered properly.

Conversely, since a view looking down from above and taken from above onto the character is generally unobstructed and less difficult to model than a view at face height, relatively few cameras situated over the height are necessary for achieving quality modelling.

These general principles lead to a higher density of cameras for the vertical range of the low horizontal planes HP1, HP1′, HP2 and HP2′ than for the vertical range of the high horizontal planes HP3 and HP4.

In accordance with the invention, the pairs of cameras C1-C4, C7-C8, C2-C3, or C5-C6 are distributed around the scene in such a manner as to have inter-pair spacings E1a, E1b, Etc or Eta between two adjacent pairs of cameras that are larger than an intra-pair spacing e of one of the two corresponding adjacent pairs of cameras, and the computation device 310 is configured in such a manner as to apply stereoscopy digital processing by comparison between images produced by a camera, e.g. C5 of a first pair of cameras C5-C6, and images produced by a camera, e.g. C4 of a second pair of cameras C1-C4 that is adjacent to the first pair of cameras C5-C6, in order to produce additional modelling data.

An inter-pair spacing between two pairs of cameras is defined in this example as the distance separating the two cameras that are closest to each other from the two pairs of cameras in question, such as, for example E1a, which corresponds to the distance between cameras C4 and C7, and which represents the inter-pair distance between the pairs C1-C4 and C7-C8.

FIG. 3A represents an unrolled cylindrical projection of the locations of the cameras of FIG. 1B, CP1 to CP8, CP1′ to CP8′, CP1″ to CP8″, and CP1′″ to CP8′″, which projection is similar to the projection shown in FIG. 2, and FIG. 3C shows, in particular, the projection of the cameras of angular portion AP.

The description below is limited to angular portion AP, but it should be understood that, by symmetry, said description extends to the angular portions AP′, AP″, and AP′″.

A table 500, shown in FIG. 5B, specifies associations between cameras and is recorded in a computer memory in the form of a file accessible to the digital processing device 310, these associations indicating to said digital processing device to apply stereoscopy digital processing by comparison between the image data of the cameras associated two-by-two.

This table indicates associations A between the cameras of the pairs of cameras C1-C4, C7-C8, C5-C6, and C2-C3, which associations are shown by the ellipses in solid (uninterrupted) lines in FIG. 3A, and it also indicates associations A′ between the cameras C1 & C2, C3 & C1′, C4 & C5, C6 & C4′, C4 & C7, and C2 & C6, which belong to respective ones of different pairs, shown by the ellipses in dashed lines in FIG. 3A.

The addition of these associations A′ makes it possible, with the number of cameras remaining constant, to increase the quantity of information usable for 3D modelling by photogrammetry.

These associations may be determined by a person in charge of optimizing the system for a given modelling and for given objectives, and they are valid for the first example and for the second example, which is described in more detail below.

The dimensions indicated numerically in FIG. 3C are expressed in meters (m) and correspond to the distances between the planes in which the cameras are situated, for the particular cases when they are arranged at the surface of a virtual surface S having the shape of a sphere of center Cs and of radius Rs of 4 meters, centered on the scene 110, as indicated in FIG. 1B.

Naturally, the placement of the cameras may be modified depending on the type of scene to be modelled and on the precise objectives of the modelling.

FIG. 3C indicates that the pairs of cameras C1-C4, C2-C3, C5-C6, and C7-C8 each have substantially the same intra-pair spacing e; the cameras of the associations of cameras C4 & C7, C2 & C6, C4 & C5, and C3 & C1′ have, between them, respective inter-pair spacings E1a, E1b, E1c, and E1d; the cameras of the associations of cameras C1 & C2, and C6 & C4′ having, between them, respective inter-pair spacings E2a and E2b.

The inter-pair spacings E1a, E1b, E1c, and E1d may be greater than the intra-pair spacing e by a factor F1 at least equal to 1.4, and preferably at least equal to 1.5, and less than 2.2, and preferably less than 1.9, and the inter-pair spacings E2a and E2b may be greater than the inter-pair spacings E1a, E1b, E1c, and E1d by a factor F2 at least equal to 1.2, and preferably at least equal to 1.4, and less than 2.2, and preferably less than 1.9.

The factors F1 and F2 above secure a significant reduction in the number of cameras necessary compared with using the single intra-pair spacing e while also making it possible to deduce, by stereoscopic processing, information that is significantly different from the information than can be deduced by using pairs of cameras separated by spacings of single value e.

Varying the spacings between the cameras in this way makes it possible to obtain a mix of spacings and to considerably increase the richness of the information used by the modelling algorithm implemented by the computation device.

However, the invention is not limited to the factors F1 and F2 given above, and the dimensions e, E1a, E1b, E1c, E1d, E2a, and E2b may vary continuously and not be single values for a given arrangement of cameras, the important point being to mix the spacings between the cameras.

In order to obtain stereoscopic information that mixes a broad range of spacings between the cameras, the intra-pair spacing e is preferably relatively small, e.g. such that its ratio to the radius Rs of a sphere on which the cameras are arranged, e/Rs, is less than 0.35, and more preferably less than or equal to 0.26, and greater than or equal to 0.09.

The intra-pair spacing e and the inter-pair spacings E1a and E1b are, in this example, approximately 1 m, 1.6 m, and 1.7 m, respectively, E1c and E1d being, in this example, approximately 2 m, and E2a and E2b being, in this example, approximately 3 m, these values being given to within 10% when the radius Rs of said sphere is 4 m.

FIGS. 4A-1, 4A-2 and 4A-3 show variant arrangements of cameras, defining elementary patterns, each of which can cover an angular portion of arbitrary angular width, and that can be repeated around a scene in such a manner as to surround it partially or completely, and these figures use the same graphic conventions as FIG. 3A.

When a scene needs to be completely surrounded by cameras, it is possible to repeat the same elementary pattern four times as in the first and second examples, but it is also possible to use elementary patterns that cover the angular portions of 30°, 45°, 60°, 120°, or 180° repeated respectively 9 times, 8 times, 6 times, 3 times, and 2 times, or any combination of elementary patterns.

The inventors have determined that, by means of the mixing, firstly of the horizontal and vertical orientations of pairs of cameras, and secondly of the spacings between the cameras of the associations of cameras, the modelling algorithms generally have a richness of information about the scene that is greater than if, for a set number of cameras, a single spacing were used between associated cameras, thereby leading to a qualitative improvement in the modelling.

The inventors have also determined that the degradation in the quality of information coming from associations of cameras not exhibiting substantially vertical mutual alignment or substantially horizontal alignment (i.e. misalignment of about 1° or less, and in any event clearly less than 5°), such as the cameras of the associations of cameras of the second example C1 & C2, C3 & C1′, C4 & C5 and C6 & C4′, may advantageously be compensated for by extending the surface on which the cameras are distributed, and thus the region from which the information comes.

In order to benefit from the advantages of such alignments deviating from the horizontal and from the vertical without the reduction in the quality of the information due to the misalignment becoming prohibitive, two associated cameras may preferably be aligned in a direction forming an angle of more than 5° but not exceeding 20°, and preferably not exceeding 15°, with a horizontal plane or with a vertical direction.

For example, as seen in FIG. 3C, the misalignment angles β1 and β2 of the cameras C4 and C5 firstly, and C1 and C2 secondly, with a horizontal level, HP1′ or HP2′, extend the surface covered by the elementary pattern of the second example relative to the first example.

The enlargement of the surface covered can be seen by comparing the angular portion AP of FIG. 3A corresponding to the second example that takes advantage of this enlargement with the same angular portion AP of the first example shown by FIG. 3B, in which the associated cameras are horizontally or vertically aligned.

Thus, the arrangement of the cameras and the associations between them are defined in such a manner that the collected information comes from a broad observation surface in almost continuous manner, as can been seen by the surfaces covered by the ellipses in FIG. 3A, and not from a narrow region, as in FIG. 3B, or from a set of mutually separate regions, thereby enabling an algorithm implemented by the digital processing device to perform the 3D modelling effectively.

Another advantage of the mix of the spacings between the cameras of the associations of cameras is the increase in the modelling volume.

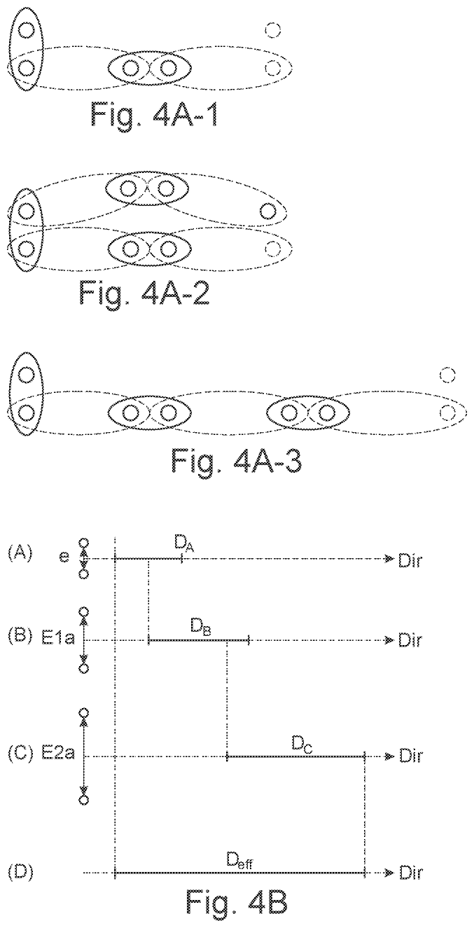

As shown diagrammatically in FIG. 4B for cameras having spaces e, E1a and E2a, the range of depths actually surveyed by a pair of cameras during a stereoscopic measurement, i.e. the depths for which usable information can be obtained, depends on the spacing between the two cameras in question.

Two cameras spaced apart by a small amount survey a range of depths D_{A} that is relatively narrow and close to the cameras in a direction Dir as shown by the configuration (A) of FIG. 4B, while pairs of cameras that are spaced further apart survey ranges of depths D_{B} and D_{c} that are wider and further away from the cameras, such as for the configurations (B) and (C) in FIG. 4B.

The coverage of the volumes surveyed by pairs of cameras combining small spacings with larger spacings thus makes it possible to survey a volume of the scene that is larger than when cameras having a single, common spacing are used, this principle being shown diagrammatically by the configuration (D) which shows an effective surveyed depth D_{eff} that is surveyed by three pairs of cameras of the configurations (A), (B), and (C).

The advantages of the arrangements of cameras for performing 3D modelling by photogrammetry as described above are particularly apparent for a number of cameras used lying in the range 20 to 64, more particularly in the range 24 to 58, and even more particularly in the range 24 to 48.

FIG. 5C is a diagram that diagrammatically shows a method of three-dimensionally modelling a scene by photogrammetry using the system described above, and application of said method to generating two-dimensional (2D) views of said scene.

During a step S10, in parallel with the other cameras, each of the cameras captures an image of the scene from its respective position, the cameras capturing these images during simultaneous capture steps Cap and producing digital images.

During a step S20, the digital processing device applies stereoscopic processing Stereo to the digital images coming from each of the pairs of cameras, according to the associations represented by A in the diagram and shown in the table 500 of associations between cameras of FIG. 5B, in order to produce modelling data.

In accordance with the invention, during step S20 and at the same logic level as the digital processing Stereo, the digital processing device also applies stereoscopic processing Stereo to digital images coming from cameras that belong to different pairs but that are associated two-by-two in associations represented by A′ in the diagram, matching the associations A′ indicated in the table 500 of associations between cameras, in order to produce additional modelling data.

In FIG. 5C, the arrows in solid (uninterrupted) lines interconnecting the steps S10 to S20 indicate use of data coming from cameras of the same pair; the arrows in dashed lines indicate use of data coming from cameras of different pairs.

During a step S30, the modelling data is merged to produce a 3D model of the scene surveyed by the cameras.

It should be noted that steps S10 to S30 implement methods known from the field of photogrammetry that, apart from specifying the associations of cameras belonging to different pairs and between which the computation device has to apply the stereographic processing, do not need any particular adjustment for applying the invention.

The step S30 marks the end of the 3D modelling proper, but an important application of said modelling, generating virtual images of the scene as observed from arbitrary viewpoints, is based on the 3D model for acting, during a step S40, to generate virtual images of the scene using conventional rendering methods.

1. A 3D modelling system for three-dimensionally modelling a scene by multi-view photogrammetry, which system comprises:
cameras that are configured to be grouped together in pairs of cameras that are placed around the scene to produce images of said scene with different viewpoints, the cameras in each pair of cameras having an intra-pair spacing between them, and
a digital processing device that, from the images produced by the cameras, is configured to produce modelling data by applying stereoscopy processing by comparison between the images produced by respective ones of the two cameras of each pair of cameras, in which system:
said pairs of cameras are distributed around the scene in such a manner as to have inter-pair spacings between two adjacent pairs of cameras that are larger than said certain intra-pair spacing (e); and
said digital processing device is further configured to apply stereoscopy processing by comparison between the images produced by a camera of a first one of said pairs of cameras and the images produced by a camera of a second one of said pairs of cameras, the second pair of cameras being adjacent to the first pair of cameras and spaced apart from said first pair of cameras by an inter-pair spacing that is greater than the intra-pair spacing, in order to produce additional modelling data, wherein
the cameras of said first pair of cameras are arranged side-by-side substantially in the same horizontal plane; and
the cameras of said second pair of cameras are arranged one above the other substantially in the same vertical plane.

2. The modelling system of claim 1, wherein
said camera of the second pair of cameras is situated above the other camera of the second pair of cameras;
the cameras of the second pair of cameras are situated lower than the cameras of the first pair of cameras; and
said camera of the first pair of cameras and said camera of the second pair of cameras are aligned in a direction forming an angle lying in the range 5° to 20° with a horizontal plane or with a vertical axis.

3. The modelling system of claim 2, wherein said cameras are distributed around the scene over a virtual surface in the shape of a sphere having a radius, wherein said intra-pair spacing is configured so that an algebraic ratio of said intra-pair spacing to said radius is less than 0.35.

4. The modelling system of claim 3, wherein said inter-pair spacings between two adjacent pairs of cameras are larger than said intra-pair spacing by a factor at least equal to 1.4.

5. The modelling system of claim 4, wherein:
said cameras are distributed around the scene in such a manner as to form a third pair of cameras having an inter-pair spacing with the second pair of cameras that is greater than or equal to the inter-pair spacing between the second pair of cameras and the first pair of cameras; and
the computation device is configured to apply said stereoscopy digital processing by comparison between the images produced by a camera of the third pair of cameras and the images produced by one of the cameras of the second pair of cameras, in order to produce additional modelling data.

6. The modelling system of claim 5, wherein:
the cameras of said third pair of cameras are arranged side-by-side in the same horizontal plane;
the third pair of cameras is offset vertically relative to the first pair of cameras;
said first and third pairs of cameras are offset horizontally relative to each other and a camera of the third pair of cameras is aligned vertically with a camera of the first pair of cameras;
the second pair of cameras is offset horizontally relative to the first and third pairs of cameras; and
the computation device is configured to apply stereoscopy digital processing by comparison between:
the images produced by the cameras of said first and third pairs of cameras that are in vertical alignment; and/or
the images produced by the cameras of said second and third pairs of cameras.

7. The modelling system of claim 6, wherein the inter-pair spacing between said first and third pairs of cameras is greater than said intra-pair spacing and is less than or equal to the inter-pair spacing between said second and third pairs of cameras.

8. The modelling system of claim 7, wherein said first, second, and third pairs of cameras define a pattern that is repeated around the scene.

9. The modelling system of claim 1, wherein said cameras are distributed around the scene over a virtual surface in the shape of a sphere having a radius, wherein said intra-pair spacing is configured so that an algebraic ratio of said intra-pair spacing to said radius is less than 0.35.

10. The modelling system of claim 1, wherein said inter-pair spacings between two adjacent pairs of cameras are larger than said intra-pair spacing by a factor at least equal to 1.4.

11. The modelling system of claim 1, wherein:
said cameras are distributed around the scene in such a manner as to form a third pair of cameras having an inter-pair spacing with the second pair of cameras that is greater than or equal to the inter-pair spacing between the second pair of cameras and the first pair of cameras; and
the computation device is configured to apply said stereoscopy digital processing by comparison between the images produced by a camera of the third pair of cameras and the images produced by one of the cameras of the second pair of cameras, in order to produce additional modelling data.

12. The modelling system of claim 1, wherein:
the cameras of said third pair of cameras are arranged side-by-side in the same horizontal plane;
the third pair of cameras is offset vertically relative to the first pair of cameras;
said first and third pairs of cameras are offset horizontally relative to each other and a camera of the third pair of cameras is aligned vertically with a camera of the first pair of cameras;
the second pair of cameras is offset horizontally relative to the first and third pairs of cameras; and
the computation device is configured to apply stereoscopy digital processing by comparison between:
the images produced by the cameras of said first and third pairs of cameras that are in vertical alignment; and/or
the images produced by the cameras of said second and third pairs of cameras.

13. The modelling system of claim 1, wherein the inter-pair spacing between said first and third pairs of cameras is greater than said intra-pair spacing and is less than or equal to the inter-pair spacing between said second and third pairs of cameras.

14. The modelling system of claim 1, wherein said first, second, and third pairs of cameras define a pattern that is repeated around the scene.
